(19) United States
(12) Patent Application Publication
(10) Pub. No.: US 2025/0146852 A1
(43) Pub. Date: May 8, 2025

(54) PITOT TUBE FLOWMETER, GAS ANALYSIS DEVICE, AND GAS ANALYSIS METHOD

(71) Applicant: HORIBA, LTD., Kyoto-shi, Kyoto (JP)

(72) Inventors: Naoto MIZUTANI, Kyoto-shi, Kyoto (JP); Makoto NAGAOKA, Kyoto-shi, Kyoto (JP); Kentaro INOUE, Kyoto-shi, Kyoto (JP); Masaru URAOKA, Kyoto-shi, Kyoto (JP); Hirotaka ISEKI, Kyoto-shi, Kyoto (JP)

(73) Assignee: HORIBA, LTD., Kyoto-shi, Kyoto (JP)

(21) Appl. No.: 18/835,696

(22) PCT Filed: Mar. 2, 2023
(86) PCT No.: PCT/JP2023/007823

§ 371 Date: Aug. 2, 2024

(30) Foreign Application Priority Data
Mar. 23, 2022 (JP) 2022-047373

(51) Int. Cl. G01F 1/46; G01P 5/165

(52) U.S. Cl. CPC G01F 1/46; G01P 5/165

(57) ABSTRACT

The present invention makes a pitot tube type flowmeter less affected by the flow velocity distribution caused by the flow passage shape on the upstream side, and includes a pitot tube having total pressure holes for detecting a total pressure of a fluid and static pressure holes for detecting a static pressure of the fluid, and a differential pressure sensor that is connected to the pitot tube and detects a differential pressure between the total pressure and the static pressure. The pitot tube includes a main tube portion, and a plurality of branch tube portions, which branches off from the main tube portion and in which the total pressure holes and the static pressure holes are formed. Each of the main tube portion and the plurality of branch tube portions has a shape that reduces a pressure loss.

### TECHNICAL FIELD

The present invention relates to a pitot tube type flowmeter, a gas analysis device, and a gas analysis method.

### BACKGROUND ART

For example, in a vehicle-mounted exhaust gas analysis device, a pitot tube type flowmeter is provided in a pipe through which exhaust gas discharged from a vehicle flows, and the flow rate of the exhaust gas is measured by the pitot tube type flowmeter.

Here, the pitot tube type flowmeter is calibrated using a straight pipe. On the other hand, in actual exhaust gas measurement, various pipes are connected to the pipe in which the pitot tube type flowmeter is installed. For this reason, various flow passage such as a linear flow passage, a bent flow passage, and a merged flow passage, in which a plurality of flow passages is merged, are formed in the flow passage on the upstream side of the pitot tube type flowmeter. This causes a drift flow, a swirl flow, and the like, changing the flow velocity distribution in the pipe from that at the time of calibration as illustrated in FIG. 12. As a result, in actual exhaust gas measurement, the flow velocity distribution is different from that at the time of calibration, causing an error in the measured flow rate.

### CITATION LIST

### Patent Literature

Patent Literature 1: JP 2014-20808 A

### SUMMARY OF INVENTION

### Technical Problem

Therefore, the present invention has been made in view of the above-described problem, and a main object thereof is to make a pitot tube type flowmeter less affected by the flow velocity distribution caused by the flow passage shape on the upstream side.

### Solution to Problem

A pitot tube type flowmeter according to the present invention includes: a pitot tube having total pressure holes for detecting a total pressure of a fluid and static pressure holes for detecting a static pressure of the fluid; and a differential pressure sensor that is connected to the pitot tube and detects a differential pressure between the total pressure and the static pressure. The pitot tube includes: a main tube portion that includes a connection port to which the differential pressure sensor is connected, and in which the total pressure holes and the static pressure holes are formed; and a plurality of branch tube portions that branches off from the main tube portion and in which the total pressure holes and the static pressure holes are formed, and each of the main tube portion and the plurality of branch tube portions has a shape that reduces a pressure loss.

### Advantageous Effects of Invention

According to the present invention configured as described above, it is possible to make a pitot tube type flowmeter less affected by the flow velocity distribution caused by the flow passage shape on the upstream side.

### BRIEF DESCRIPTION OF DRAWINGS

FIG. 1 is a schematic view illustrating a gas analysis device according to an embodiment of the present invention.

FIG. 2 is a perspective view illustrating a pitot tube of a pitot tube type flowmeter of the embodiment.

FIG. 3 is a front view and a rear view illustrating the pitot tube of the pitot tube type flowmeter of the embodiment.

FIG. 4 is a left side view and a right side view illustrating the pitot tube of the pitot tube type flowmeter of the embodiment.

FIG. 5 is a plan view and a bottom view illustrating the pitot tube of the pitot tube type flowmeter of the embodiment.

FIG. 6 is a cross-sectional view taken along line A-A of the embodiment.

FIG. 7 is a cross-sectional view taken along line B-B of the embodiment.

FIG. 8 is a cross-sectional view taken along line C-C of the embodiment.

FIG. 9 is a front view and a right side view illustrating a pitot tube of a pitot tube type flowmeter of a modified embodiment.

FIG. 10 is a perspective view illustrating a configuration of a pitot tube according to a modified embodiment.

FIG. 11 is a perspective view illustrating a configuration of a pitot tube according to a modified embodiment.

FIG. 12 is a schematic diagram illustrating a flow velocity distribution at the time of calibration and a flow velocity distribution at the time of actual exhaust gas measurement.

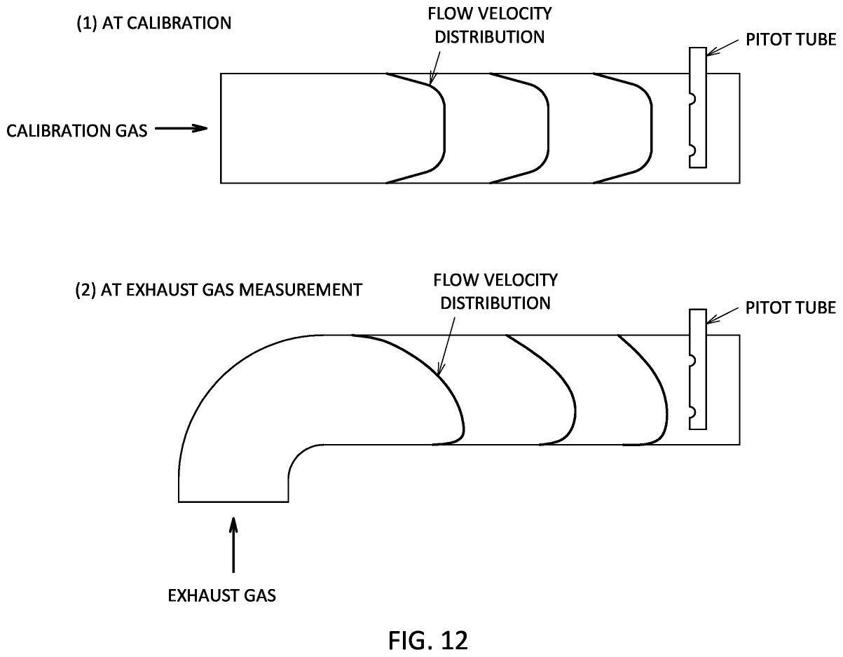

### DESCRIPTION OF EMBODIMENTS

Next, the technology of the present invention will be described in more detail with reference to examples. However, the present invention is not limited by the following description.

As described above, a pitot tube type flowmeter according to the present invention includes: a pitot tube having total pressure holes for detecting a total pressure of a fluid and static pressure holes for detecting a static pressure of the fluid; and a differential pressure sensor that is connected to the pitot tube and detects a differential pressure between the total pressure and the static pressure. The pitot tube includes: a main tube portion that includes a connection port to which the differential pressure sensor is connected, and in which the total pressure holes and the static pressure holes are formed; and a plurality of branch tube portions that branches off from the main tube portion and in which the total pressure holes and the static pressure holes are formed, and each of the main tube portion and the plurality of branch tube portions has a shape that reduces a pressure loss.

According to such a pitot tube type flowmeter, since the pitot tube includes the main tube portion in which total pressure holes and static pressure holes are formed and a plurality of branch tube portions in which total pressure holes and static pressure holes are formed, the measurement points of the total pressure and the static pressure can be two-dimensionally increased in the flow passage cross section. As a result, the total pressure and the static pressure can be measured averagely in the two-dimensional plane, and an error in the measured flow rate can be reduced even if the flow velocity distribution changes with respect to the time of calibration. In addition, since each of the main tube portion and the plurality of branch tube portions has a shape that reduces the pressure loss, it is possible to reduce a pressure loss caused by providing the pitot tube in the flow passage.

In order to increase the measurement points of the total pressure and the static pressure to reduce errors in the measured flow rate, a plurality of the total pressure holes and a plurality of the static pressure holes are preferably formed in each of the main tube portion and the plurality of branch tube portions.

In order to further average the total pressure and the static pressure with respect to the flow velocity distribution created in the pipe, the main tube portion and the plurality of branch tube portions are preferably provided at equal intervals in the circumferential direction in the flow passage cross section.

In order to average the total pressure and the static pressure while simplifying the configuration of the pitot tube, the two branch tube portions preferably branch off to both sides with respect to the main tube portion, so that the pitot tube has a cross shape when viewed from a fluid flow direction.

In order to measure the total pressure and the static pressure averagely in a two-dimensional plane, the total pressure holes formed in the main tube portion and the plurality of branch tube portions are preferably located in the same plane, and the static pressure holes formed in the main tube portion and the plurality of branch tube portions are preferably located in the same plane.

A portion of the main tube portion extending to the connection port from a branch point at which the plurality of branch tube portions branches off is preferably longer than other tube portions.

With this configuration, the main tube portion of the pitot tube can be easily fixed to the pipe. In addition, the branch tube portions branching off from the branch point can be separated from the inner surface of the pipe, and the pressure loss due to the pitot tube can be reduced.

In order to place the main tube portion and the plurality of branch tube portions in the pipe while providing the connection port outside the pipe, the main tube portion is preferably fixed to the pipe through which the fluid flows.

In order to reduce the pressure loss due to the pitot tube, each of the main tube portion and the plurality of branch tube portions preferably has a tapered shape at at least one of an upstream portion or a downstream portion in a fluid flow direction. That is, the shape for reducing a pressure loss of each of the main tube portion and the plurality of branch tube portions is formed in a tapered shape. Each of the main tube portion and the plurality of branch tube portions preferably has a tapered shape at least at the upstream portion in the fluid flow direction.

The area ratio of the pitot tube to a flow passage through which the fluid flows is preferably 15% or more and 40% or less.

A gas analysis device according to the present invention includes: the above-described pitot tube type flowmeter fixed to a gas pipe through which gas flows; and a gas analyzer that measures a concentration of a predetermined component contained in the gas. The gas pipe is preferably provided with a sampling portion that samples the gas and guides the gas to the gas analyzer.

According to this gas analysis device, since an error of the measured flow rate by the pitot tube type flowmeter can be reduced, the discharge amount of the predetermined component can be accurately measured from the concentration obtained by the gas analyzer.

In addition, as a configuration that makes the effect of the pitot tube type flowmeter of the present invention prominent, the gas pipe preferably includes an elbow pipe, and the pitot tube type flowmeter is preferably provided on the downstream side of the elbow pipe.

Further, a gas analysis method using the pitot tube type flowmeter is also an aspect of the present invention.

### Embodiment of Present Invention

Hereinafter, an embodiment of an exhaust gas analysis device using a pitot tube type flowmeter according to the present invention will be described with reference to the drawings.

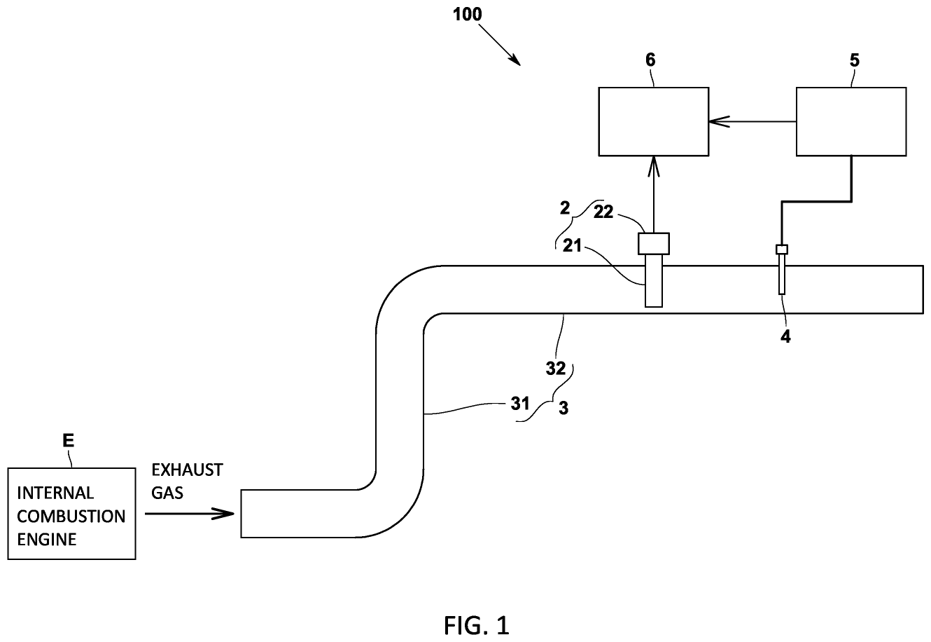

As illustrated in FIG. 1, the gas analysis device 100 of the present embodiment is of a vehicle-mounted type that is mounted on a vehicle, for example, and analyzes exhaust gas discharged from an internal combustion engine E of the vehicle in real time during traveling on a road. The gas analysis device 100 is of a direct sampling type that directly measures the concentration of the collected exhaust gas without diluting the exhaust gas. Furthermore, the gas analysis device 100 can also analyze in real time the exhaust gas discharged from the internal combustion engine E of a vehicle being simulated in a driving simulation on a chassis dynamometer during the simulated driving. Also, the gas analysis device 100 may be of a stationary type, for example, other than a vehicle-mounted type.

Specifically, as shown in FIG. 1, the gas analysis device 100 includes a flowmeter 2 for measuring the flow rate of exhaust gas discharged from the internal combustion engine E, and a gas analyzer 5 for measuring the concentration of a component to be measured contained in the exhaust gas.

The flowmeter 2 is provided in a gas pipe 3 through which the exhaust gas discharged from the internal combustion engine E flows. The gas pipe 3 includes an elbow pipe 31, and the flowmeter 2 is provided in the straight pipe portion 32 on the downstream side of the elbow pipe 31. The elbow pipe 31 and the straight pipe portion 32 may be separate members, and in that case, they are connected by a joint. Here, the straight pipe distance from the inlet of the straight pipe portion 32 to the flowmeter 2 is preferably a large distance of 4D or more or 150 mm or more when the pipe diameter (inner diameter) of the straight pipe portion 32 is defined as D. A specific configuration of the flowmeter 2 will be described later.

In addition, the gas pipe 3 is provided with a sampling portion 4 for sampling and guiding the exhaust gas to the gas analyzer 7. The exhaust gas sampled by the sampling portion 4 is guided to the gas analyzer 5, and the concentration of the component to be measured (For example, CO, CO₂, NOₓ, THC, or CH₄, H₂, O₂, H₂O, NH₃, or the like) contained in the exhaust gas is continuously measured, or PN (number of particles) or PM (particulate matter) is measured. The concentration signal of each component obtained by the gas analyzer 5 is sent to a high-level calculation device 6, and is used for calculation of the discharge mass of each component together with the flow rate signal obtained by the flowmeter 2.

### <Specific Configuration of Flowmeter 2>

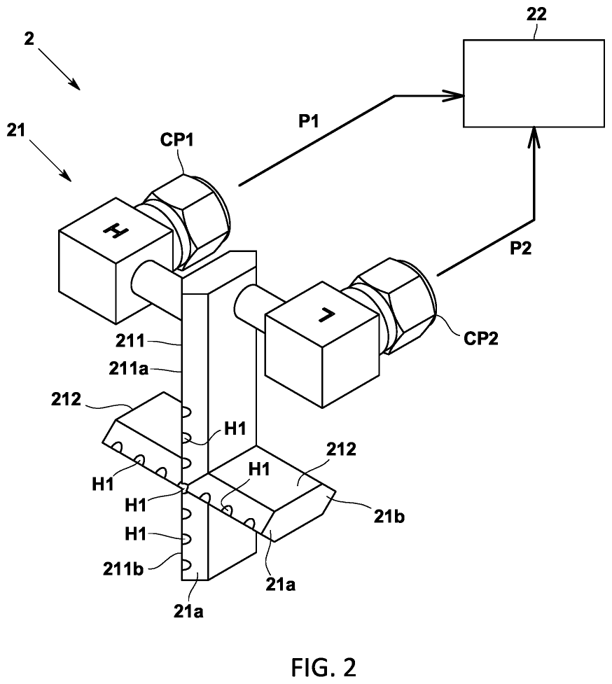

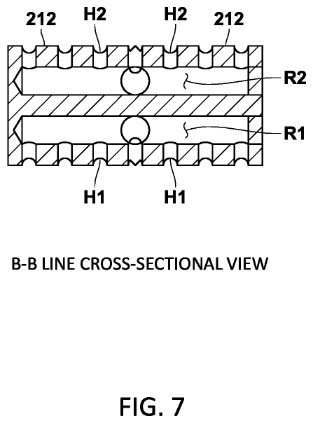

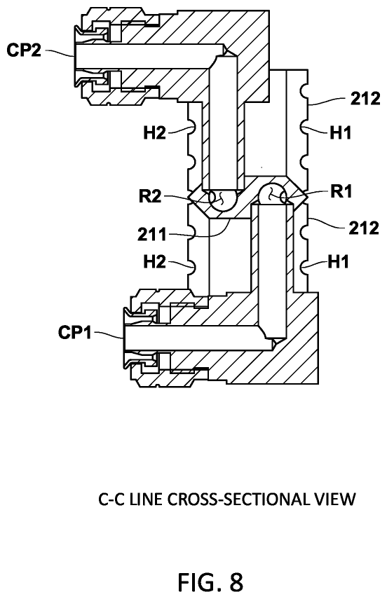

Hereinafter, a specific configuration of the flowmeter 2 of the present embodiment will be described with reference to FIGS. 2 to 8.

The flowmeter 2 of the present embodiment is a pitot tube type flowmeter that detects the differential pressure ΔP between the total pressure P1 and the static pressure P2 of the exhaust gas and calculates the flow rate of the exhaust gas.

Specifically, as shown in FIGS. 2 to 5, the flowmeter 2 includes a pitot tube 21, which includes total pressure holes H1 for detecting the total pressure P1 of the exhaust gas and static pressure holes H2 for detecting the static pressure P2 of the exhaust gas, and a differential pressure sensor 22 (see FIG. 2) connected to the pitot tube 21 to detect a differential pressure ΔP between the total pressure P1 and the static pressure P2. The flowmeter 2 further includes a flow rate calculation portion (not illustrated) that calculates the flow rate of the exhaust gas using the differential pressure ΔP obtained by the differential pressure sensor 22.

As illustrated in FIGS. 2 to 5, the pitot tube 21 includes connection ports CP1 and CP2 to which the differential pressure sensor 22 is connected, and includes a main tube portion 211, in which total pressure holes H1 and static pressure holes H2 are formed, and a plurality of branch tube portions 212, which branches off from the main tube portion 211 and in which total pressure holes H1 and static pressure holes H2 are formed.

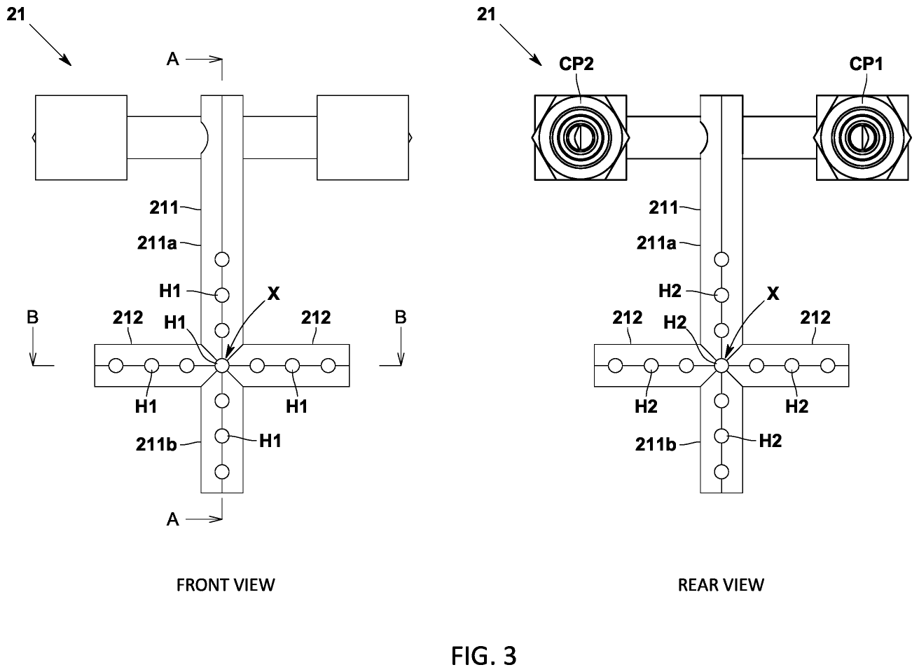

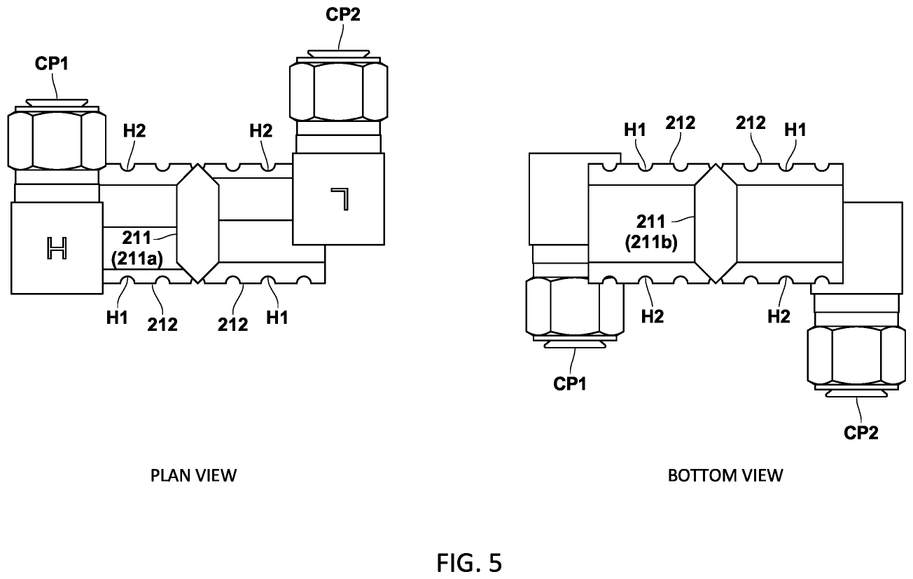

Each of the main tube portion 211 and the plurality of branch tube portions 212 has a straight pipe shape, and a plurality of total pressure holes H1 and a plurality of static pressure holes H2 are formed in each of the main tube portion 211 and the plurality of branch tube portions 212. Here, as illustrated in FIG. 5 and the like, the total pressure holes H1 are formed in upstream portions 21a in the fluid flow direction in the main tube portion 211 and the plurality of branch tube portions 212, and the static pressure holes H2 are formed in downstream portions 21b in the fluid flow direction in the main tube portion 211 and the plurality of branch tube portions 212. As illustrated in FIG. 3 and the like, the total pressure holes H1 and the static pressure holes H2 of the present embodiment preferably have the same shape (the same opening size), and preferably have a circular shape in a front view. The total pressure holes H1 and the static pressure holes H2 do not need to have the same shape.

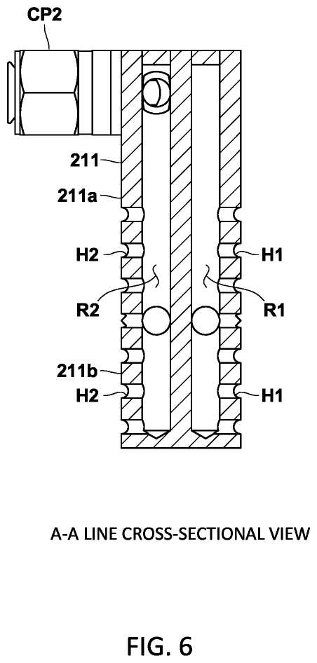

As shown in FIGS. 6 to 8, a total pressure flow passage R1 communicating with the plurality of total pressure holes H1 and a static pressure flow passage R2 communicating with the plurality of static pressure holes H2 are formed inside the main tube portion 211 and the plurality of branch tube portions 212. The total pressure flow passage R1 and the static pressure flow passage R2 are independent from each other. The total pressure flow passage R1 is connected to the connection port CP1 for total pressure, and the static pressure flow passage R2 is connected to the connection port CP2 for static pressure. As a result, the differential pressure sensor 22 detects the differential pressure ΔP between the total pressure P1 averaged by the plurality of total pressure holes H1 and the static pressure P2 averaged by the plurality of static pressure holes H2.

As shown in FIG. 3, the main tube portion 211 and the plurality of branch tube portions 212 are provided at equal intervals in the circumferential direction in the flow passage cross section (cross section orthogonal to the flow direction). In the present embodiment, since the two branch tube portions 212 symmetrically branch off to both sides with respect to the main tube portion 211, the pitot tube 21 has a cross shape when viewed from the flow direction of the exhaust gas. That is, the two branch tube portions 212 are configured to orthogonally branch off from one branch point X (middle portion) in the length direction in the main tube portion 211.

In the pitot tube 21, a portion of the main tube portion 211 extending toward the connection ports CP1 and CP2 from the branch point X at which the two branch tube portions 212 branch off (an upper portion 211a in FIG. 3 and the like) is longer than the other tube portions. Here, the other tube portions are the two branch tube portions 212 and the portion of the main tube portion 211 extending away from the connection ports CP1 and CP2 from the branch point X (a lower portion 211b in FIG. 3 and the like).

In such a configuration, the main tube portion 211 is fixed to the straight pipe portion 32 of the gas pipe 3. Specifically, in the pitot tube 21, the upper portion 211a of the main tube portion 211 is fixed to a side wall (for example, an upper wall) of the straight pipe portion 32. Also, the pitot tube 21 is fixed such that the branch point X of the two branch tube portions 212 coincides with the center of the flow passage cross section of the straight pipe portion 32. Here, the other tube portions 212 and 211b are separated from the inner surface of the straight pipe portion 32. As a result, the pressure loss due to the pitot tube 21 (specifically, the other tube portions 212 and 211b) is reduced. In addition, from the viewpoint of reducing the pressure loss, it is conceivable that the area ratio of the pitot tube 21 to the flow passage provided with the pitot tube 21 is 10% or more and 40% or less, preferably 10% or more and 30 or less, and more preferably 10% or more and 20% or less.

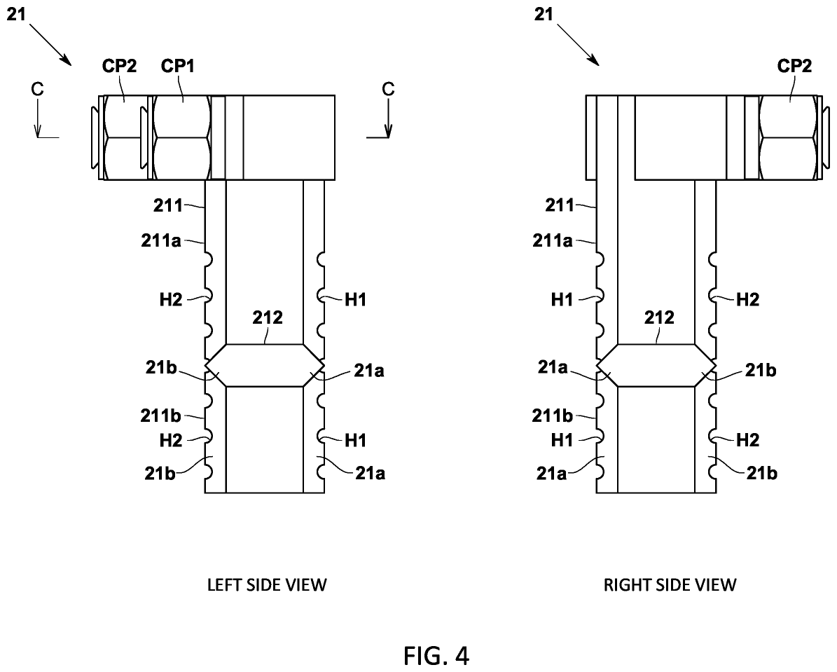

Further, as illustrated in FIGS. 4 and 5, the total pressure holes H1 formed in the main tube portion 211 and the plurality of branch tube portions 212 are located in the same plane, and the static pressure holes H2 formed in the main tube portion 211 and the plurality of branch tube portions 212 are located in the same plane. Here, as illustrated in FIG. 3, the plurality of total pressure holes H1 formed in the main tube portion 211 are formed at symmetrical positions with respect to the branch point X (located at the center of the flow passage cross section). A total pressure hole H1 is also formed at the branch point X. The plurality of total pressure holes H1 formed in the branch tube portions 212 are also formed at symmetrical positions with respect to the branch point X. The plurality of static pressure holes H2 formed in the main tube portion 211 are also formed at symmetrical positions with respect to the branch point X. A static pressure hole H2 is also formed at the branch point X. The plurality of static pressure holes H2 formed in the branch tube portions 212 are also formed at symmetrical positions with respect to the branch point X.

As shown in FIGS. 2 and 4, each of the main tube portion 211 and the plurality of branch tube portions 212 has a tapered shape at least at the upstream portion 21a in the fluid flow direction. In the present embodiment, an example in which the downstream portion 21b also has a tapered shape is shown. This tapered shape is an example of a shape for reducing a pressure loss. Specifically, the upstream portions 21a and the downstream portions 21b of the main tube portion 211 and the plurality of branch tube portions 212 have a tapered shape having a triangular cross section. With such a configuration, the pressure loss due to the pitot tube 21 can be reduced. In the upstream portions 21a and the downstream portions 21b, the plurality of total pressure holes H1 and the plurality of static pressure holes H2 are formed in the vicinity of the apex of the tapered shape, whereby the total pressure and the static pressure can be accurately measured. Note that FIGS. 2, 4, and the like illustrate a triangular cross-sectional shape having an apex angle of 90 degrees, but the apex angle is not limited to 90 degrees. For example, the triangular cross-sectional shape may have an apex angle of 60 degrees, for example. The apex angle may be in the range of 30 degrees to 150 degrees. The upstream portions 21a and the downstream portions 21b of the main tube portion 211 and the plurality of branch tube portions 212 may have a trapezoidal cross-sectional shape, a circular cross-sectional shape, an elliptical cross-sectional shape, or a streamline shape.

### Effects of Present Embodiment

According to the gas analysis device 100 of the present embodiment configured as described above, since the pitot tube 21 includes the main tube portion 211 in which total pressure holes H1 and static pressure holes H2 are formed and the plurality of branch tube portions 212 in which total pressure holes H1 and static pressure holes H2 are formed, the measurement points of the total pressure P1 and the static pressure P2 can be two-dimensionally increased in the flow passage cross section. As a result, the total pressure P1 and the static pressure P2 can be measured averagely in the two-dimensional plane, and an error of the measured flow rate can be reduced even if the flow velocity distribution changes with respect to the time of calibration. Therefore, since an error of the measured flow rate by the pitot tube type flowmeter 2 can be reduced, the discharge amount of the predetermined component can be accurately measured from the concentration obtained by the gas analyzer 5. In addition, since each of the main tube portion 211 and the plurality of branch tube portions 212 has a shape that reduces the pressure loss, it is possible to reduce a pressure loss caused by providing the pitot tube 21 in the flow passage.

### OTHER EMBODIMENTS

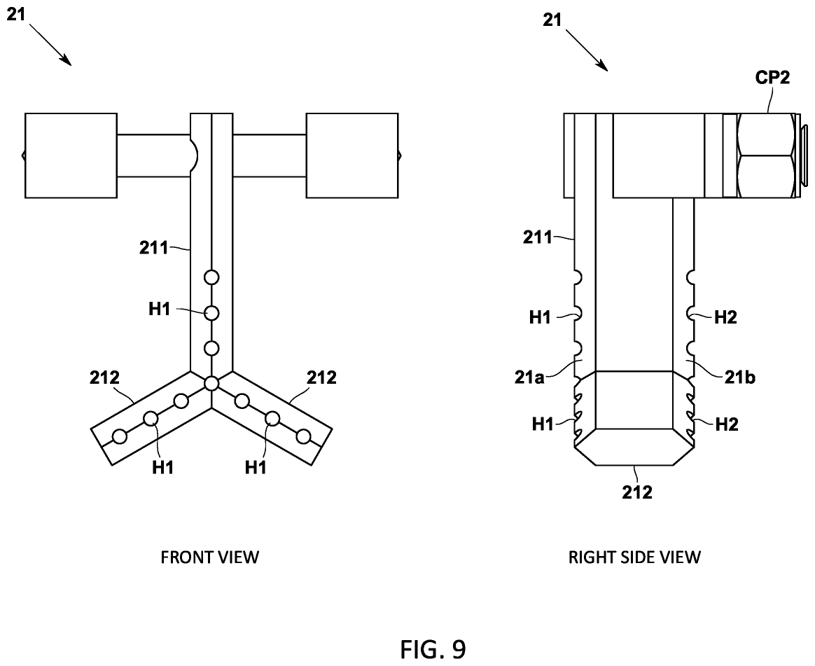

For example, in the above embodiment, the plurality of branch tube portions 212 branches off orthogonally from the middle portion of the main tube portion 211, but may branch off orthogonally from the distal end portion (end portion opposite to the connection ports CP1, CP2) of the main tube portion 211. Also, as illustrated in FIG. 9, a plurality of (here, two) branch tube portions 212 may branch off obliquely from the distal end portion of the main tube portion 211 (here, the angle formed with the main tube portion 211 is 120 degrees). In addition, the angle formed by the main tube portion 211 and the one branch tube portion 212, the angle formed by the main tube portion 211 and the other branch tube portion 212, or the angle formed by the branch tube portions 212 may be different from each other.

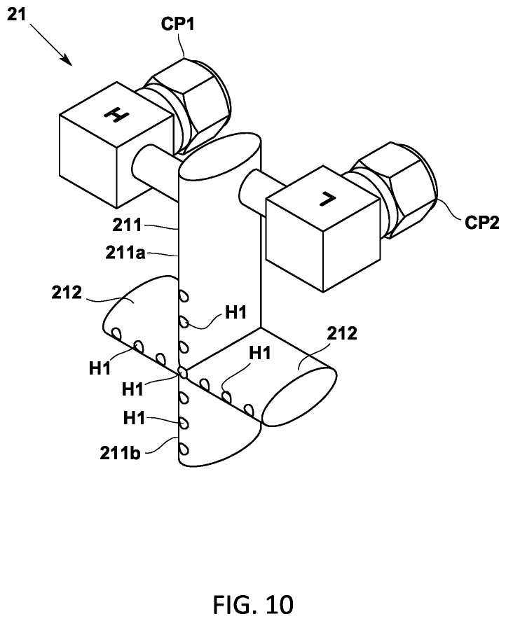

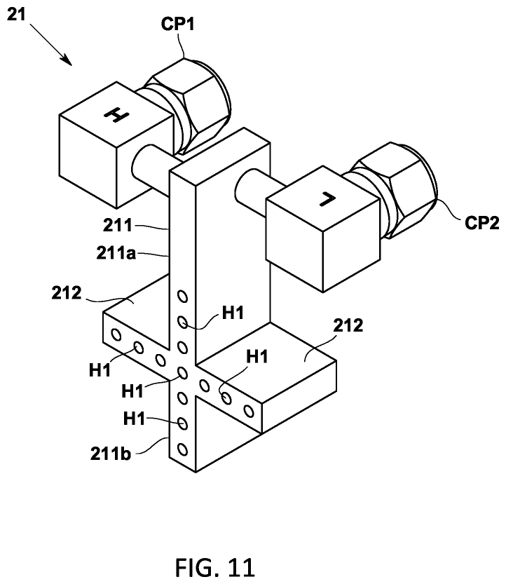

In the above embodiment, the upstream portion 21a and the downstream portion 21b of each of the main tube portion 211 and the branch tube portions 212 have a tapered shape, and the other portions have a shape having a constant width. However, as illustrated in FIG. 10, the entire cross-sectional shape of the main tube portion 211 and the branch tube portions 212 may be an elliptical shape or a streamline shape to reduce a pressure loss. Furthermore, as illustrated in FIG. 11, the main tube portion 211 and the branch tube portions 212 may have a shape having a constant width from the upstream side toward the downstream side without having a tapered shape.

In the above embodiment, the plurality of branch tube portions 212 branches off from one branch point in the length direction with respect to the main tube portion 211, but one or a plurality of branch tube portions 212 may branch off from a plurality of branch points in the length direction with respect to the main tube portion 211.

In the above embodiment, the plurality of total pressure holes H1 is formed at symmetrical positions with respect to the branch point X, and the plurality of static pressure holes H2 is also formed at symmetrical positions with respect to the branch point X. However, the plurality of static pressure holes H2 may be formed at asymmetrical positions with respect to the branch point X.

In the above embodiment, the exhaust gas discharged from the internal combustion engine E is analyzed. However, gas discharged from a fuel cell or a hydrogen engine may be analyzed.

In the above embodiment, the gas analysis device is an exhaust gas analysis device, but may analyze other gases (For example, gas in a chemical plant or an environmental gas such as the atmosphere). In this case, the pitot tube type flowmeter measures the flow rate of the gas in the chemical plant or the environmental gas in addition to the flow rate of the exhaust gas.

In addition, various modifications and combinations of the embodiments may be made without departing from the gist of the present invention.

### INDUSTRIAL APPLICABILITY

According to the present invention, it is possible to make a pitot tube type flowmeter less affected by the flow velocity distribution caused by the flow passage shape on the upstream side.

### REFERENCE SIGNS LIST

100 exhaust gas analysis device
2 pitot tube type flowmeter
H1 total pressure hole
H2 static pressure hole
CP1, CP2 connection port
21 pitot tube
211 main tube portion
211a portion extending to connection port
X branch point
212 branch tube portion
22 differential pressure sensor
3 gas pipe
31 elbow pipe
4 sampling portion
5 gas analyzer

1. A pitot tube type flowmeter comprising:
a pitot tube having total pressure holes for detecting a total pressure of a fluid and static pressure holes for detecting a static pressure of the fluid; and
a differential pressure sensor that is connected to the pitot tube and detects a differential pressure between the total pressure and the static pressure, wherein
the pitot tube includes:
a main tube portion that includes a connection port to which the differential pressure sensor is connected, and in which the total pressure holes and the static pressure holes are formed; and
a plurality of branch tube portions that branches off from the main tube portion and in which the total pressure holes and the static pressure holes are formed, and
each of the main tube portion and the plurality of branch tube portions has a shape that reduces a pressure loss.

2. The pitot tube type flowmeter according to claim 1, wherein a plurality of the total pressure holes and a plurality of the static pressure holes are formed in each of the main tube portion and the plurality of branch tube portions.

3. The pitot tube type flowmeter according to claim 1, wherein the main tube portion and the plurality of branch tube portions are provided at equal intervals in a circumferential direction in a flow passage cross section.

4. The pitot tube type flowmeter according to claim 1, wherein two of the branch tube portions branch off to both sides with respect to the main tube portion, so that the pitot tube has a cross shape when viewed from a fluid flow direction.

5. The pitot tube type flowmeter according to claim 1, wherein
the total pressure holes formed in the main tube portion and the plurality of branch tube portions are located in a same plane, and
the static pressure holes formed in the main tube portion and the plurality of branch tube portions are located in a same plane.

6. The pitot tube type flowmeter according to claim 1, wherein a portion of the main tube portion extending to the connection port from a branch point at which the plurality of branch tube portions branches off is longer than other tube portions.

7. The pitot tube type flowmeter according to claim 1, wherein the main tube portion is fixed to a pipe through which the fluid flows.

8. The pitot tube type flowmeter according to claim 1, wherein each of the main tube portion and the plurality of branch tube portions has a tapered shape at an upstream portion and a downstream portion in a fluid flow direction.

9. The pitot tube type flowmeter according to claim 1, wherein an area ratio of the pitot tube to a flow passage through which the fluid flows is 15% or more and 40% or less.

10. A gas analysis device comprising:
the pitot tube type flowmeter according to claim 1, the pitot tube type flowmeter being fixed to a gas pipe through which gas flows; and
a gas analyzer that measures a concentration of a predetermined component contained in the gas,
wherein the gas pipe is provided with a sampling portion that samples the gas and guides the gas to the gas analyzer.

11. The gas analysis device according to claim 10, wherein
the gas pipe includes an elbow pipe, and
the pitot tube type flowmeter is provided on a downstream side of the elbow pipe.

12. A gas analysis method using the pitot tube type flowmeter according to claim 1.
